(19) United States
(12) Patent Application Publication
(10) Pub. No.: US 2026/0075560 A1
(43) Pub. Date: Mar. 12, 2026

(54) Vendor Identification Exchange In NAS And RRC Messages In Mobile Communications

(71) Applicant: MediaTek Inc., Hsinchu City (TW)

(72) Inventors: Kuo-Chun Lee, San Jose, CA (US); Keng-Ming Huang, Hsinchu City (TW); Jen-Chien Liu, Hsinchu City (TW); Ren-Huang Liu, Hsinchu City (TW); Chia-Chun Hsu, Hsinchu City (TW)

(73) Assignee: MediaTek Inc., Hsinchu City (TW)

(21) Appl. No.: 19/304,597

(22) Filed: Aug. 20, 2025

Related U.S. Application Data
(60) Provisional application No. 63/691,405, filed on Sep. 6, 2024.

(51) Int. Cl. H04W 60/00; H04W 76/27

(52) U.S. Cl. CPC H04W 60/00; H04W 76/27

(57) ABSTRACT

Techniques pertaining to vendor identification (ID) exchange in non-access stratum (NAS) and radio resource control (RRC) messages in mobile communications are described. A user equipment (UE) exchanges vendor information with a network. The vendor information includes either or both of the following: (i) a vendor identification (ID); and (ii) a vendor version.

### CROSS REFERENCE TO RELATED PATENT APPLICATION(S)

The present disclosure claims the priority benefit of U.S. Patent Application Ser. No. 63/691,405, filed 6 Sep. 2024, the content of which herein being incorporated by reference in its entirety.

### TECHNICAL FIELD

The present disclosure is generally related to mobile communications and, more particularly, to vendor identification (ID) exchange in non-access stratum (NAS) and radio resource control (RRC) messages in mobile communications.

### BACKGROUND

In wireless communications such as mobile communications under the current 3^{rd} Generation Partnership Project (3GPP) specification, with respect to user equipment (UE) information request and response, a network can send a UE Information Request to a UE to inquire about some information. The UE can reply with a UE Information Response for the corresponding information at the UE. On the other hand, there has been some proprietary implementation to signal the UE/infrastructure vendor identification (ID). Knowing the UE vendor ID from infrastructure vendor or knowing infrastructure vendor ID from the UE vendor can facilitate optimization of some vendor-dependent procedures at the UE and the infrastructure.

However, at the time of the present disclosure, there is no standardized method to signal UE/infrastructure vendor ID. Specifically, proprietary methods of signaling may not be robust. For example, a proprietary method can have some assumption that the values or information elements (IEs) are never used in the future. This assumption has no absolute guarantee. Besides, if there is some change of the information, it would be very difficult to manage the change which may be compatible among multiple versions of products. Moreover, behavior can be unclear when a non-supporting receiver receives such a proprietary information. Therefore, there is a need for a solution of vendor ID exchange in NAS and RRC messages in mobile communications.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions pertaining to vendor ID exchange in NAS and RRC messages in mobile communications. It is believed that implementations of one or more of the schemes proposed herein may address or otherwise alleviate the issues described above.

In one aspect, a method may involve a UE exchanging vendor information with a network. The vendor information may include either or both of the following: (i) a vendor ID; and (ii) a vendor version.

In another aspect, a method may involve a network node of a network exchanging vendor information with a UE. The vendor information may include either or both of the following: (i) a vendor ID; and (ii) a vendor version.

It is noteworthy that, although the description provided herein may be in the context of certain radio access technologies, networks, and network topologies such as 5^{th} Generation (5G)/New Radio (NR), Beyond Fifth-Generation (B5G) and 6^{th} Generation (6G) mobile communications, the proposed concepts, schemes and any variation(s)/derivative(s) thereof may be implemented in, for and by other types of radio access technologies, networks and network topologies such as, for example and without limitation, 4G/Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a diagram of an example design under a proposed scheme in accordance with the present disclosure.

FIG. 3 is a diagram of an example design under a proposed scheme in accordance with the present disclosure.

FIG. 4 is a diagram of an example design under a proposed scheme in accordance with the present disclosure.

FIG. 5 is a diagram of an example design under a proposed scheme in accordance with the present disclosure.

FIG. 6 is a diagram of an example design under a proposed scheme in accordance with the present disclosure.

FIG. 7 is a diagram of an example design under a proposed scheme in accordance with the present disclosure.

FIG. 8 is a block diagram of an example communication system under a proposed scheme in accordance with the present disclosure.

FIG. 9 is a flowchart of a first example process under a proposed scheme in accordance with the present disclosure.

FIG. 10 is a flowchart of a second example process under a proposed scheme in accordance with the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to vendor ID exchange in NAS and RRC messages in mobile communications. According to the present disclosure, a number of possible solutions may be implemented separately or jointly. That is, although these possible solutions may be described below separately, two or more of these possible solutions may be implemented in one combination or another.

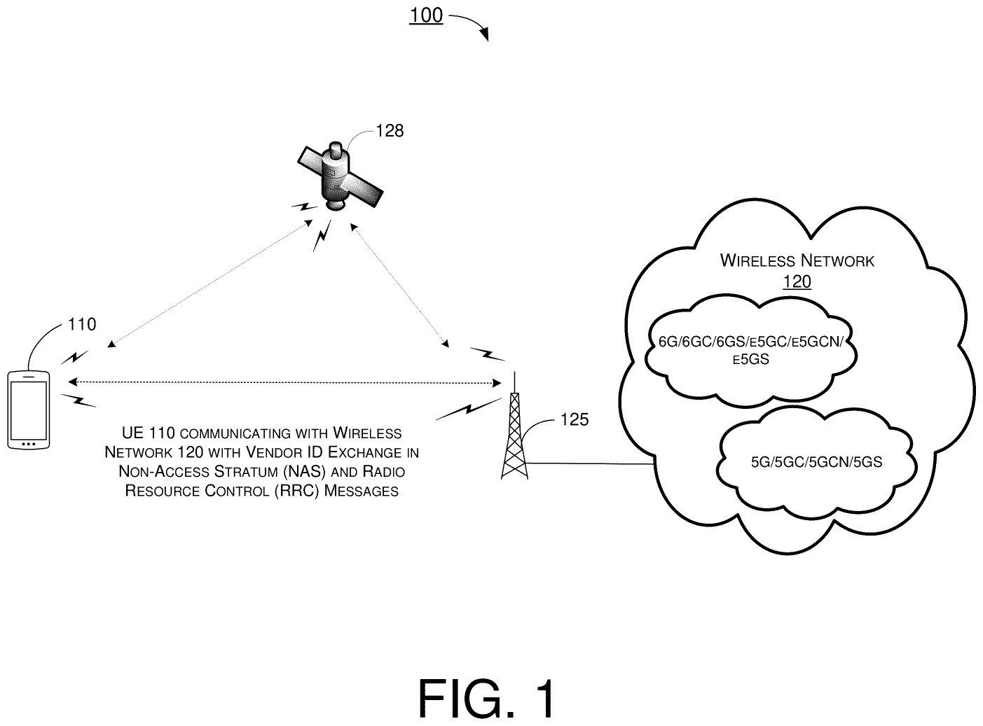

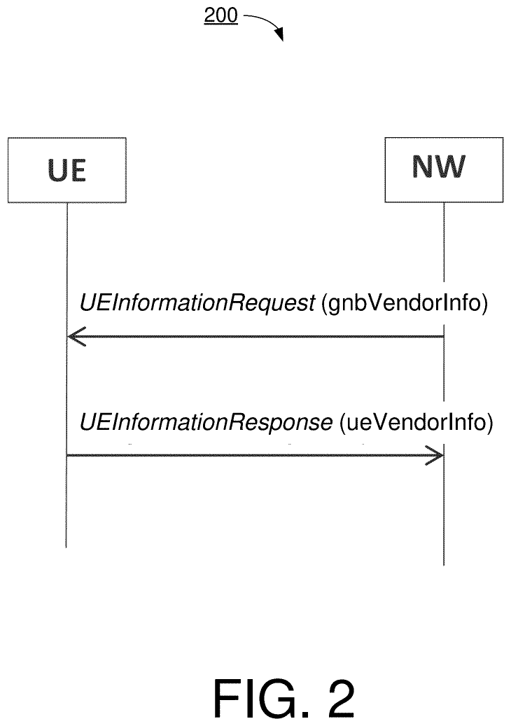

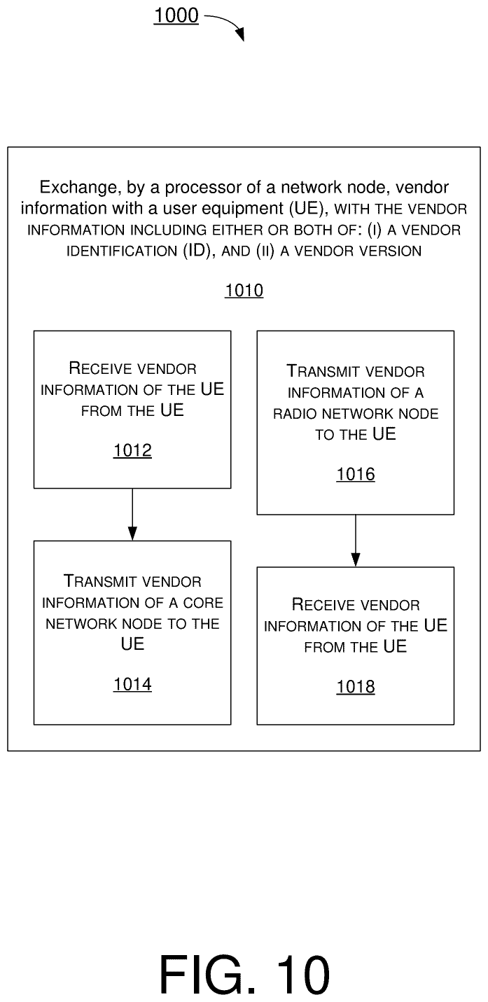

FIG. 1 illustrates an example network environment 100 in which various solutions and schemes in accordance with the present disclosure may be implemented. FIG. 2˜FIG. 10 illustrate examples of implementation of various proposed schemes in network environment 100 in accordance with the present disclosure. The following description of various proposed schemes is provided with reference to FIG. 1˜FIG. 10.

Referring to FIG. 1, network environment 100 involves a UE 110 (in wireless communication with a wireless network 120 (e.g., a 6G mobile network including an NTN and a TN) via a terrestrial network node 125 (e.g., an evolved Node-B (eNB), a Next Generation Node-B (gNB), or a transmission/reception point (TRP)) and/or a non-terrestrial network node 128 (e.g., a satellite). For example, the terrestrial network node 125 and/or the non-terrestrial network node 128 may form a non-terrestrial network (NTN) serving cell for wireless communication with UE 110. In some implementations, UE 110 may be a smartphone, a wearable device, an IoT device such as an NB-IoT UE or an enhanced machine-type communication (eMTC) UE (e.g., a bandwidth reduced low complexity (BL) UE or a coverage enhancement (CE) UE). In such communication environment, UE 110, network 120, terrestrial network node 125, and non-terrestrial network node 128 may implement various schemes pertaining to vendor ID exchange in NAS and RRC messages in accordance with the present disclosure, as described below.

It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately. Moreover, as used herein, a Non-Access Stratum (NAS) layer may refer to a layer in the 5G protocol stack, which is higher than the radio resource control (RRC) layer, on top of a packet data convergence protocol (PDCP) layer, a radio control link (RLC) layer, a medium access control (MAC) layer, a physical (PHY) layer, or so forth.

FIG. 2 illustrates an example design 200 under a proposed scheme in accordance with the present disclosure. Under the proposed scheme, some RRC messages may be utilized to signal infrastructure (e.g., radio network node) vendor information, and some RRC messages may be utilized to signal the UE vendor information. In design 200, a UE Information Request message may be utilized by a network to signal or otherwise provide infrastructure vendor information to a UE. Correspondingly, a UE Information Response message may be utilized by the UE to signal or otherwise provide vendor information to the network. Under the proposed scheme, the vendor information (e.g., in a vendor information IE) may include one or two fields, namely: Vendor ID and, optionally, vendor version (which may be either a combined hardware and software version or a pure software version).

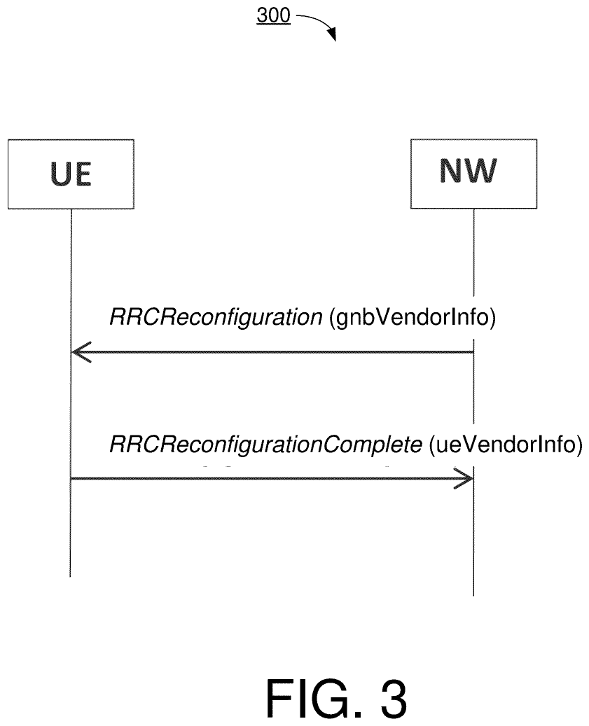

FIG. 3 illustrates an example design 300 under a proposed scheme in accordance with the present disclosure. Under the proposed scheme, some RRC messages may be utilized to signal infrastructure (e.g., radio network node) vendor information, and some RRC messages may be utilized to signal the UE vendor information. In design 300, a RRC Reconfiguration message may be utilized by a network to signal or otherwise provide infrastructure vendor information to a UE. Correspondingly, a RRC Reconfiguration Complete message may be utilized by the UE to signal or otherwise provide vendor information to the network. Under the proposed scheme, the vendor information (e.g., in a vendor information IE) may include one or two fields, namely: vendor ID and, optionally, vendor version (which may be either a combined hardware and software version or a pure software version).

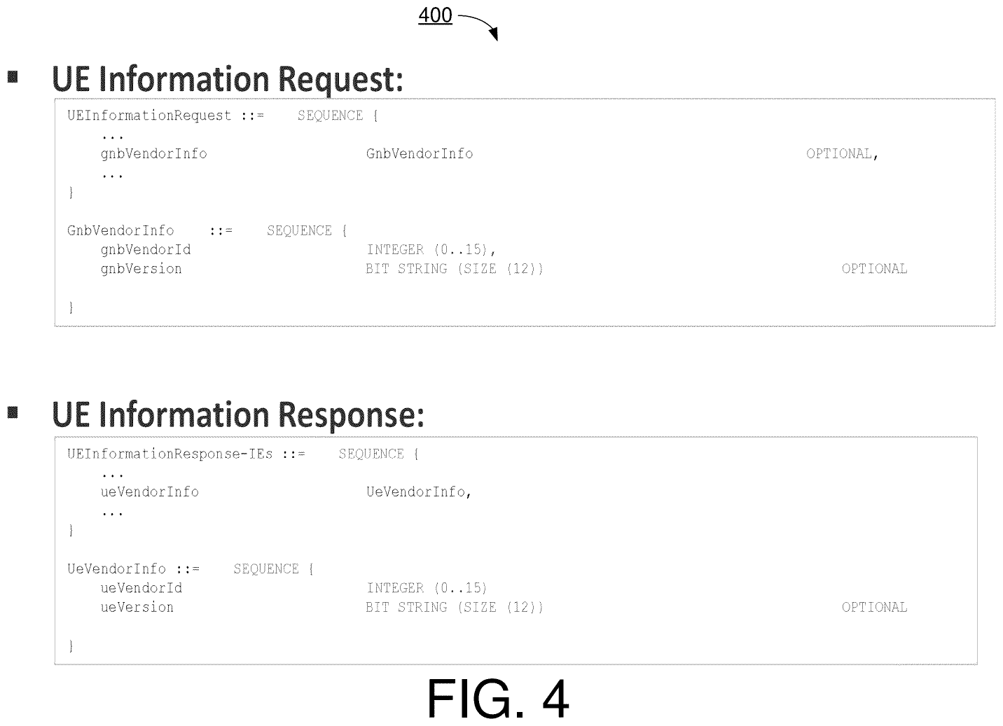

FIG. 4 illustrates an example design 400 under a proposed scheme in accordance with the present disclosure. Design 400 may pertain to an example of at least a portion of the contents of a UE Information Request message and a UE Information Response message utilized in design 200.

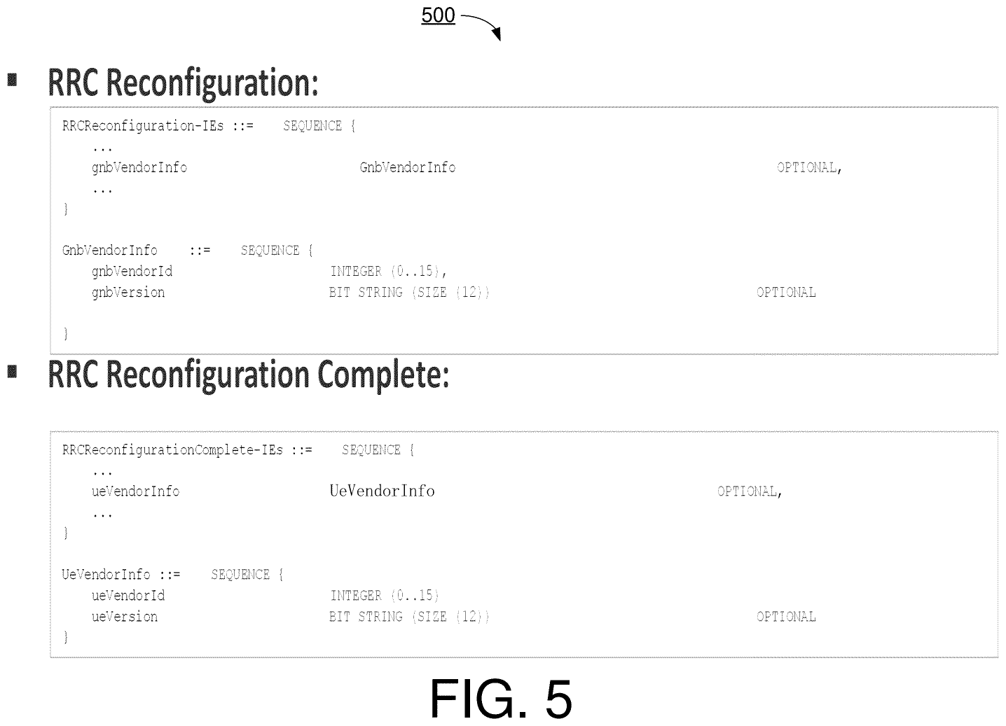

FIG. 5 illustrates an example design 500 under a proposed scheme in accordance with the present disclosure. Design 500 may pertain to an example of at least a portion of the contents of a RRC Reconfiguration message and a RRC Reconfiguration Complete message utilized in design 300.

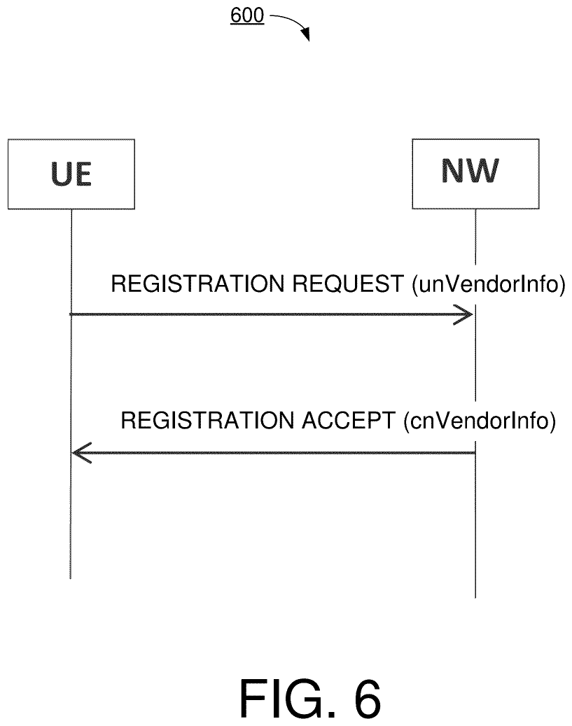

FIG. 6 illustrates an example design 600 under a proposed scheme in accordance with the present disclosure. Under the proposed scheme, some NAS messages may be utilized to signal the UE vendor information, and some NAS messages may be utilized to signal the core network vendor information. In design 600, a Registration Request message may be utilized by a UE to signal or otherwise provide UE vendor information to a network. Moreover, a Registration Accept message may be utilized by the network to signal or otherwise provide core network vendor information to the UE. Under the proposed scheme, the vendor information may be sent in security protected messages (e.g., ciphered and integrity protected) to avoid information breach. For instance, the UE Information Request/Response messages, as well as the RRC Reconfiguration and RRC Reconfiguration Complete messages, may be security protected messages. Moreover, the REGISTRATION REQUEST/ACCEPT messages may be transmitted in plain text, so that the UE and network may need to wait after a NAS SECURITY MODE COMPLETE message has been completed, if there is no NAS security context established in the first REGISTRATION REQUEST/ACCEPT messages.

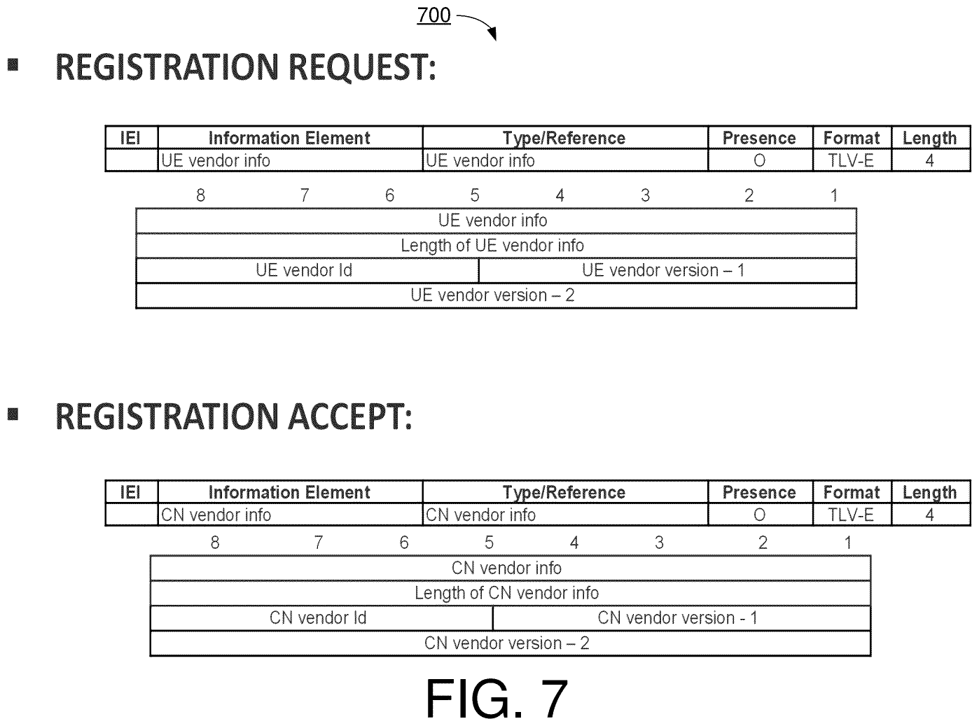

FIG. 7 illustrates an example design under a proposed scheme in accordance with the present disclosure. Design 700 may pertain to an example of at least a portion of the contents of a Registration Request message and a Registration Accept message utilized in design 600.

In view of the above, under the various proposed schemes in accordance with the present disclosure, a method of exchanging vendor information in a wireless communication network (e.g., network 120) may involve a UE (e.g., UE 110) transmitting vendor information of the UE to a network node (e.g., terrestrial network node 125 or non-terrestrial network node 128) and/or receiving, by the UE, vendor information of a core network node from the network node, by using NAS messages. The vendor information may include at least one of the following: (i) vendor identity/identification, and (ii) vendor software version or a combination of software and hardware version.

Additionally, under the various proposed schemes in accordance with the present disclosure, a method of exchanging vendor information in a wireless communication network (e.g., network 120) may involve a UE (e.g., UE 110) receiving vendor information of a radio network node from a network node (e.g., terrestrial network node 125 or non-terrestrial network node 128) and/or replying, by the UE, to the network node with vendor information of the UE, by using RRC messages. The vendor information may include at least one of the following: (i) vendor identity/identification, and (ii) vendor software version or a combination of software and hardware version.

### Illustrative Implementations

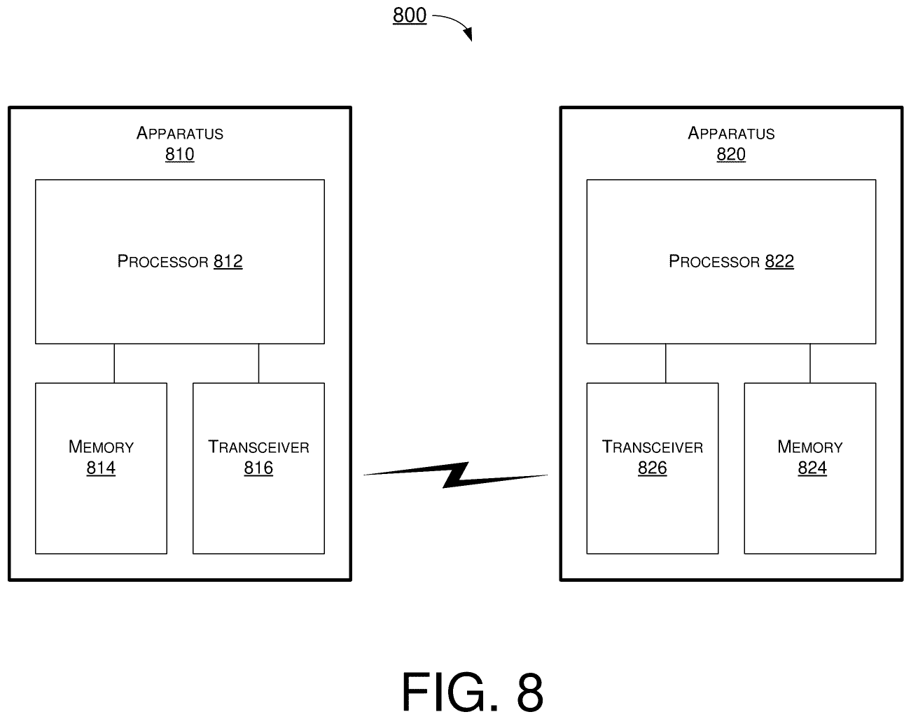

FIG. 8 illustrates an example communication system 800 having at least an example apparatus 810 and an example apparatus 820 in accordance with an implementation of the present disclosure. Each of apparatus 810 and apparatus 820 may perform various functions to implement schemes, techniques, processes and methods described herein pertaining to vendor ID exchange in NAS and RRC messages in mobile communications, including the various schemes described above with respect to various proposed designs, concepts, schemes, systems and methods described above, including network environment 100, as well as processes described below.

Each of apparatus 810 and apparatus 820 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 810 and apparatus 820 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 810 and apparatus 820 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 810 and apparatus 820 may be implemented in a smart thermostat, a smart fridge, a smart door lock, a wireless speaker or a home control center. When implemented in or as a network apparatus, apparatus 810 and/or apparatus 820 may be implemented in an eNB in an LTE, LTE-Advanced or LTE-Advanced Pro network or in a gNB or TRP in a 5G/6G network, or an IoT network.

In some implementations, each of apparatus 810 and apparatus 820 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 810 and apparatus 820 may be implemented in or as a network apparatus or a UE. Each of apparatus 810 and apparatus 820 may include at least some of those components shown in FIG. 8 such as a processor 812 and a processor 822, respectively, for example. Each of apparatus 810 and apparatus 820 may further include one or more other components not pertinent to the proposed scheme of the present disclosure (e.g., internal power supply, display device and/or user interface device), and, thus, such component(s) of apparatus 810 and apparatus 820 are neither shown in FIG. 8 nor described below in the interest of simplicity and brevity.

In one aspect, each of processor 812 and processor 822 may be implemented in the form of one or more single-core processors, one or more multi-core processors, or one or more CISC or RISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged, and configured to perform specific tasks including those pertaining to vendor ID exchange in NAS and RRC messages in mobile communications in accordance with various implementations of the present disclosure.

In some implementations, apparatus 810 may also include a transceiver 816 coupled to processor 812. Transceiver 816 may be capable of wirelessly transmitting and receiving data. In some implementations, transceiver 816 may be capable of wirelessly communicating with different types of wireless networks of different radio access technologies (RATs). In some implementations, transceiver 816 may be equipped with a plurality of antenna ports (not shown) such as, for example, four antenna ports. That is, transceiver 816 may be equipped with multiple transmit antennas and multiple receive antennas for multiple-input multiple-output (MIMO) wireless communications. In some implementations, apparatus 820 may also include a transceiver 826 coupled to processor 822. Transceiver 826 may include a transceiver capable of wirelessly transmitting and receiving data. In some implementations, transceiver 826 may be capable of wirelessly communicating with different types of UEs/wireless networks of different RATs. In some implementations, transceiver 826 may be equipped with a plurality of antenna ports (not shown) such as, for example, four antenna ports. That is, transceiver 826 may be equipped with multiple transmit antennas and multiple receive antennas for MIMO wireless communications.

In some implementations, apparatus 810 may further include a memory 814 coupled to processor 812 and capable of being accessed by processor 812 and storing data therein. In some implementations, apparatus 820 may further include a memory 824 coupled to processor 822 and capable of being accessed by processor 822 and storing data therein. Each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non-volatile random-access memory (NVRAM) such as flash memory, solid-state memory, ferroelectric RAM (FeRAM), magnetoresistive RAM (MRAM) and/or phase-change memory.

Each of apparatus 810 and apparatus 820 may be a communication entity capable of communicating with each other using various proposed schemes in accordance with the present disclosure. For illustrative purposes and without limitation, a description of capabilities of apparatus 810, as a UE (e.g., UE 110), and apparatus 820, as a network node (e.g., terrestrial network node 125 or non-terrestrial network node 128) of a network (e.g., wireless network 120 as a 5G/NR mobile network), is provided below in the context of example processes 900 and 1000.

### Illustrative Processes

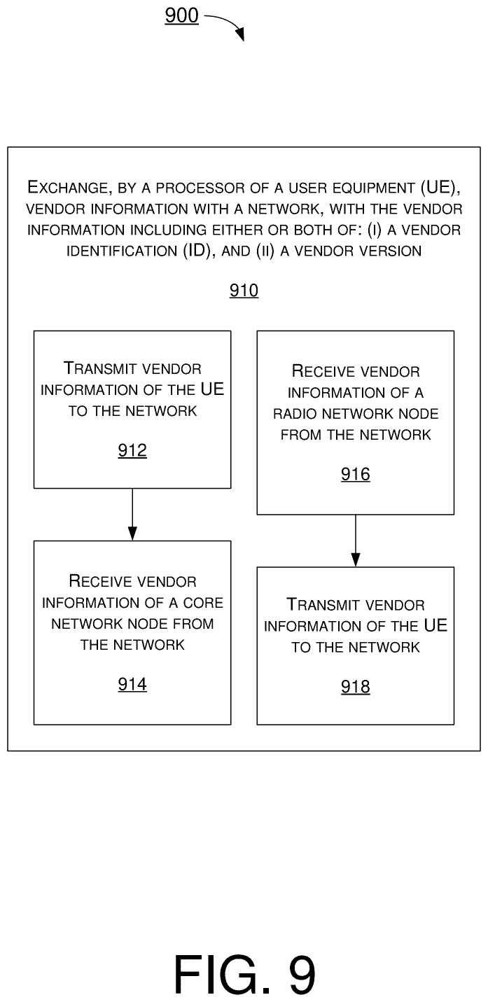

FIG. 9 illustrates an example process 900 in accordance with an implementation of the present disclosure. Process 900 may represent an aspect of implementing various proposed designs, concepts, schemes, systems and methods described above. More specifically, process 900 may represent an aspect of the proposed concepts and schemes pertaining to vendor ID exchange in NAS and RRC messages in mobile communications in accordance with the present disclosure. Process 900 may include one or more operations, actions, or functions as illustrated by one or more of blocks. Although illustrated as discrete blocks, various blocks of process 900 may be divided into additional blocks, combined into fewer blocks, or eliminated, depending on the desired implementation. Moreover, the blocks/sub-blocks of process 900 may be executed in the order shown in FIG. 9 or, alternatively, in a different order. Furthermore, one or more of the blocks/sub-blocks of process 900 may be executed repeatedly or iteratively. Process 900 may be implemented by or in apparatus 810 and apparatus 820 as well as any variations thereof. Solely for illustrative purposes and without limiting the scope, process 900 is described below in the context of apparatus 810 as a UE (e.g., UE 110) and apparatus 820 as a communication entity such as a network node (e.g., non-terrestrial network node 128 or terrestrial network node 125) of a network (e.g., wireless network 120). Process 900 may begin at block 910.

At 910, process 900 may involve processor 812 of apparatus 810, as a UE (e.g., UE 110), exchanging, via transceiver 816, vendor information with a network (e.g., wireless network 120 via apparatus 820 as terrestrial network node 125 or non-terrestrial network node 128). In some implementations, the vendor information may include either or both of the following: (i) a vendor ID, and (ii) a vendor version.

In some implementations, the vendor version may include a software version or a combined hardware and software version.

In some implementations, the exchanging of the vendor information may be represented by 912 and/or 914. Moreover, the exchanging of the vendor information may involve exchanging the vendor information using NAS messages.

At 912, process 900 may involve processor 812 transmitting vendor information of the UE to the network. For instance, in transmitting the vendor information of the UE, process 900 may involve processor 812 transmitting a registration request message with the vendor information of the UE. Process 900 may optionally proceed from 912 to 914.

At 914, process 900 may involve processor 812 receiving vendor information of a core network node from the network. For instance, in receiving the vendor information of the core network node, process 900 may involve processor 812 receiving a registration accept message with the vendor information of the core network node.

Alternatively, the exchanging of the vendor information may be represented by 916 and/or 918. Moreover, the exchanging of the vendor information may involve exchanging the vendor information using RRC messages.

At 916, process 900 may involve processor 812 receiving vendor information of a radio network node from the network. For instance, in receiving the vendor information of the radio network node, process 900 may involve processor 812 receiving a UE information request message with the vendor information of the radio network node. Alternatively, in receiving the vendor information of the radio network node, process 900 may involve processor 812 receiving a RRC reconfiguration message with the vendor information of the radio network node. Process 900 may optionally proceed from 916 to 918.

At 918, process 900 may involve processor 812 transmitting vendor information of the UE to the network. For instance, in transmitting the vendor information of the UE, process 900 may involve processor 812 transmitting a UE information response message with the vendor information of the UE. Alternatively, in transmitting the vendor information of the UE, process 900 may involve processor 812 transmitting a RRC reconfiguration complete message with the vendor information of the UE.

FIG. 10 illustrates an example process 1000 in accordance with an implementation of the present disclosure. Process 1000 may represent an aspect of implementing various proposed designs, concepts, schemes, systems and methods described above. More specifically, process 1000 may represent an aspect of the proposed concepts and schemes pertaining to vendor ID exchange in NAS and RRC messages in mobile communications in accordance with the present disclosure. Process 1000 may include one or more operations, actions, or functions as illustrated by one or more of blocks. Although illustrated as discrete blocks, various blocks of process 1000 may be divided into additional blocks, combined into fewer blocks, or eliminated, depending on the desired implementation. Moreover, the blocks/sub-blocks of process 1000 may be executed in the order shown in FIG. 10 or, alternatively, in a different order. Furthermore, one or more of the blocks/sub-blocks of process 1000 may be executed repeatedly or iteratively. Process 1000 may be implemented by or in apparatus 810 and apparatus 820 as well as any variations thereof. Solely for illustrative purposes and without limiting the scope, process 1000 is described below in the context of apparatus 810 as a UE (e.g., UE 110) and apparatus 820 as a communication entity such as a network node (e.g., non-terrestrial network node 128 or terrestrial network node 125) of a network (e.g., wireless network 120). Process 1000 may begin at block 1010.

At 1010, process 1000 may involve processor 822 of apparatus 820, as a network node (e.g., terrestrial network node 125 or non-terrestrial network node 128) of a network (e.g., wireless network 120), exchanging, via transceiver 826, vendor information with a UE (e.g., apparatus 810). In some implementations, the vendor information may include either or both of the following: (i) a vendor ID, and (ii) a vendor version.

In some implementations, the vendor version may include a software version or a combined hardware and software version.

In some implementations, the exchanging of the vendor information may be represented by 1012 and/or 1014. Moreover, the exchanging of the vendor information may involve exchanging the vendor information using NAS messages.

At 1012, process 1000 may involve processor 822 receiving vendor information of the UE from the UE. For instance, in receiving the vendor information of the UE, process 1000 may involve processor 822 receiving a registration request message with the vendor information of the UE. Process 1000 may optionally proceed from 1012 to 1014.

At 1014, process 1000 may involve processor 822 transmitting vendor information of a core network node to the UE. For instance, in transmitting the vendor information of the core network node, process 1000 may involve processor 822 transmitting a registration accept message with the vendor information of the core network node.

Alternatively, the exchanging of the vendor information may be represented by 1016 and/or 1018. Moreover, the exchanging of the vendor information may involve exchanging the vendor information using RRC messages.

At 1016, process 1000 may involve processor 822 transmitting vendor information of a radio network node to the UE. For instance, in transmitting the vendor information of the radio network node, process 1000 may involve processor 822 transmitting a UE information request message with the vendor information of the radio network node. Alternatively, in transmitting the vendor information of the radio network node, process 1000 may involve processor 822 transmitting a RRC reconfiguration message with the vendor information of the radio network node. Process 1000 may optionally proceed from 1016 to 1018.

At 1018, process 1000 may involve processor 812 receiving vendor information of the UE from the UE. For instance, in receiving the vendor information of the UE, process 1000 may involve processor 822 receiving a UE information response message with the vendor information of the UE. Alternatively, in receiving the vendor information of the UE, process 1000 may involve processor 822 receiving a RRC reconfiguration complete message with the vendor information of the UE.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more; ” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
exchanging, by a processor of a user equipment (UE), vendor information with a network,
wherein the vendor information comprises either or both of:
a vendor identification (ID); and
a vendor version.

2. The method of claim 1, wherein the vendor version comprises a software version or a combined hardware and software version.

3. The method of claim 1, wherein the exchanging of the vendor information comprises:
transmitting vendor information of the UE to the network; or
receiving vendor information of a core network node from the network; or
both transmitting the vendor information of the UE to the network and receiving the vendor information of the core network node from the network.

4. The method of claim 3, wherein the exchanging of the vendor information comprises exchanging the vendor information using non-access stratum (NAS) messages.

5. The method of claim 4, wherein:
the transmitting of the vendor information of the UE comprises transmitting a registration request message with the vendor information of the UE; and
the receiving of the vendor information of the core network node comprises receiving a registration accept message with the vendor information of the core network node.

6. The method of claim 1, wherein the exchanging of the vendor information comprises:
receiving vendor information of a radio network node from the network; or
transmitting vendor information of the UE to the network; or
both receiving the vendor information of the radio network node from the network and transmitting the vendor information of the UE to the network.

7. The method of claim 6, wherein the exchanging of the vendor information comprises exchanging the vendor information using radio resource control (RRC) messages.

8. The method of claim 7, wherein:
the receiving of the vendor information of the radio network node comprises receiving a UE information request message with the vendor information of the radio network node; and
the transmitting of the vendor information of the UE comprises transmitting a UE information response message with the vendor information of the UE.

9. The method of claim 7, wherein:
the receiving of the vendor information of the radio network node comprises receiving a RRC reconfiguration message with the vendor information of the radio network node; and
the transmitting of the vendor information of the UE comprises transmitting a RRC reconfiguration complete message with the vendor information of the UE.

10. A method, comprising:
exchanging, by a processor of a network node, vendor information with a user equipment (UE),
wherein the vendor information comprises either or both of:
a vendor identification (ID); and
a vendor version.

11. The method of claim 10, wherein the vendor version comprises a software version or a combined hardware and software version.

12. The method of claim 10, wherein the exchanging of the vendor information comprises:
receiving vendor information of the UE from the UE; or
transmitting vendor information of a core network node to the UE; or
both receiving the vendor information of the UE from the UE and transmitting the vendor information of the core network node to the UE.

13. The method of claim 12, wherein the exchanging of the vendor information comprises exchanging the vendor information using non-access stratum (NAS) messages.

14. The method of claim 13, wherein:
the receiving of the vendor information of the UE comprises receiving a registration request message with the vendor information of the UE; and
the transmitting of the vendor information of the core network node comprises transmitting a registration accept message with the vendor information of the core network node.

15. The method of claim 10, wherein the exchanging of the vendor information comprises:
transmitting vendor information of a radio network node to the UE; or
receiving vendor information of the UE from the UE; or
both transmitting the vendor information of the radio network node to the UE and receiving the vendor information of the UE from the UE.

16. The method of claim 15, wherein the exchanging of the vendor information comprises exchanging the vendor information using radio resource control (RRC) messages.

17. The method of claim 16, wherein:
the transmitting of the vendor information of the radio network node comprises transmitting a UE information request message with the vendor information of the radio network node; and
the receiving of the vendor information of the UE comprises receiving a UE information response message with the vendor information of the UE.

18. The method of claim 16, wherein:
the transmitting of the vendor information of the radio network node comprises transmitting a RRC reconfiguration message with the vendor information of the radio network node; and
the receiving of the vendor information of the UE comprises receiving a RRC reconfiguration complete message with the vendor information of the UE.

19. An apparatus, comprising:
a transceiver configured to communicate wirelessly; and
a processor coupled to the transceiver and configured to perform operations comprising exchanging vendor information with a network,
wherein the vendor information comprises either or both of:
a vendor identification (ID); and
a vendor version.

20. The apparatus of claim 19, wherein the vendor version comprises a software version or a combined hardware and software version.
